(19) United States
(12) Patent Application Publication
(10) Pub. No.: US 2013/0164486 A1
(43) Pub. Date: Jun. 27, 2013

(54) ELECTRONIC DEVICE

(71) Applicant: ASAHI GLASS COMPANY, LIMITED, Chiyoda-ku (JP)

(72) Inventors: Kazuo YAMADA, Chiyoda-ku (JP); Motoshi Ono, Chiyoda-ku (JP); Mitsuru Watanabe, Chiyoda-ku (JP); Toshihiro Takeuchi, Chiyoda-ku (JP); Satoshi Takeda, Chiyoda-ku (JP)

(73) Assignee: ASAHI GLASS COMPANY, LIMITED, Chiyoda-ku (JP)

(21) Appl. No.: 13/716,812

(22) Filed: Dec. 17, 2012

Related U.S. Application Data
(63) Continuation of application No. PCT/JP2011/063717, filed on Jun. 15, 2011.

(30) Foreign Application Priority Data
Jun. 16, 2010 (JP) 2010-137641

(51) Int. Cl. C03C 27/06

(52) U.S. Cl. CPC C03C 27/06
USPC 428/76

(57) ABSTRACT

Provided is an electronic device wherein at a time of laser-sealing a space between two glass substrates, it is possible to suppress generation of a crack or a breakage etc. in the glass substrates or a sealing layer. When a cross-section of the sealing layer 6 of the electronic device is observed, the sum total of perimeter lengths of the low expansion filler and the laser absorbent present in a unit area (fluidity inhibition value) is from 0.7 to 1.3 μm⁻¹, and the sum total (thermal expansion value) of a value obtained by multiplying the area ratio of the sealing glass by the thermal expansion coefficient, and a value obtained by multiplying the sum total of the area ratios of the low expansion filler and the laser absorbent by the thermal expansion coefficient of the low expansion filler, is from 50 to 90×10⁻⁷/° C.

### TECHNICAL FIELD

The present invention relates to an electronic device comprising two glass substrates having peripheral portions sealed together and an electronic element portion provided between the substrates.

### BACKGROUND ART

A flat panel display device (FPD) such as an organic EL display (organic electro-luminescence display: OELD), a field emission display (FED), a plasma display panel (PDP) or a liquid crystal display device (LCD) has such a structure that a glass substrate for element on which a display element is formed and a sealing glass substrate are disposed to face each other and a display element is sealed in a glass package comprising two such glass substrates bonded (refer to Patent Document 1). For a solar cell such as a dye-sensitized solar cell, application of a glass package having a solar cell element (photoelectric conversion element) sealed with two glass substrates has been studied (refer to Patent Documents 2 to 4).

As a sealing material to seal two glass substrates together, an application of a sealing glass excellent in e.g. moisture resistance is in progress. Since the sealing temperature of the sealing glass is at a level of from 400 to 600° C., properties of an electronic element portion of an organic EL (OEL) element or a dye-sensitized solar cell element or the like may be deteriorated when a heating treatment is conducted by using a conventional firing furnace. To solve this problem, it is attempted to dispose a sealing material layer (fired layer of a glass material for sealing) containing a laser absorbent between sealing regions provided in peripheral portions of the two glass substrates, irradiate the sealing material layer with a laser beam to heat and melt the layer to form a sealing layer (refer to Patent Documents 1 to 4).

The sealing by laser heating can suppress a thermal influence on the electronic element portion, but since such a sealing is a process of rapidly heating and rapidly cooling the sealing material layer, a residual stress tends to be formed on a bonding interface between a sealing layer being a melted-solidified layer of the glass material for sealing and the glass substrate, or in the vicinity of the interface. The residual stress formed on the bonding interface or its vicinity causes a crack or a breakage etc. in the sealing layer or the glass substrate, or lowers the bonding strength or the bonding reliability between the glass substrate and the sealing layer.

Particularly, a solar cell employs glass substrates composed of soda lime glass having a relatively large thickness in order to improve durability or reduce production cost. Since soda lime glass has a large thermal expansion coefficient, a crack or a breakage tends to be formed in a glass substrate by irradiation of laser beam, or a crack or a peeling tends to occur between the glass substrate and the sealing layer. Further, when the thickness of the glass substrate is large, a residual stress tends to be large, which may cause a crack or a breakage of the sealing layer or the glass substrate, or lowering of bonding strength or bonding reliability between the glass substrate and the sealing layer.

In Patent Document 5, the particle size of a low expansion filler to be mixed into the sealing glass is set to be at most the thickness T of the sealing material layer, and soda lime glass substrates are sealed together by laser heating using a glass material for sealing containing low expansion filler particles having a particle size within a range of from 0.5 T to 1 T in an amount within a range of from 0.1 to 50 volume %. However, in Patent Document 5, the content of particles having a relatively small particle size is not considered. In a case where the low expansion filler contains a large amount of particles having a relatively small particle size, the fluidity of the sealing material in molten state decreases, and as a result, a crack or a breakage of the sealing layer or the glass substrate tends to occur and the bonding strength or the bonding reliability between the glass substrate and the sealing layer tend to decrease.

### PRIOR ART DOCUMENTS

### Patent Documents

Patent Document 1: JP-A-2006-524419
Patent Document 2: JP-A-2008-115057
Patent Document 3: WO2009/128527
Patent Document 4: JP-A-2010-103094
Patent Document 5: WO2010/061853

### DISCLOSURE OF INVENTION

### Technical Problem

It is an object of the present invention to provide an electronic device which realizes suppression of generation of problems such as a crack or a breakage of a glass substrate or a sealing layer even if laser heating is applied for sealing two glass substrates together.

### Solution to Problem

The electronic device according to an embodiment of the present invention is an electronic device which comprises:

a first glass substrate having a first surface having a first sealing region;

a second glass substrate having a second surface having a second sealing region corresponding to the first sealing region and disposed so that the second surface faces the first surface of the first glass substrate with a predetermined gap;

an electronic element portion provided between the first glass substrate and the second glass substrate; and

a sealing layer formed between the first sealing region of the first glass substrate and the second sealing region of the second glass substrate so as to seal the electronic element portion, the sealing layer comprising a melt-bonded layer of a sealing material containing a sealing glass, a low expansion filler and a laser absorbent;

wherein the sealing layer has a fluidity inhibition value of from 0.7 to 1.3 μm⁻¹, the fluidity inhibition value being represented by the sum of perimeters of the low expansion filler and the laser absorbent present in a unit area of a cross-section of the sealing layer; and the sealing layer has a thermal expansion value of from 50 to 90×10⁻⁷/° C., the thermal expansion value being represented by the sum of a value that is the area ratio of the sealing glass in the unit area of the cross-section of the sealing layer multiplied by the thermal expansion coefficient of the sealing glass, and a value that is the area ratio of the low expansion filler and the laser absorbent in the unit area of the cross-section of the sealing layer multiplied by the thermal expansion coefficient of the low expansion filler.

### Advantageous Effects of Invention

With the electronic device according to an embodiment of the present invention, it is possible to suppress a crack or a breakage etc. in a glass substrate or a sealing layer at a time of laser-sealing two glass substrates together. Accordingly, it is possible to provide with good reproducibility an electronic device wherein the sealing property between two glass substrates and its reliability are improved.

### BRIEF DESCRIPTION OF DRAWINGS

FIG. 1 is a cross-sectional view showing the construction of an electronic device according to an embodiment of the present invention.

FIGS. 2A-D are cross-sectional views showing a process for producing an electronic device according to an embodiment of the present invention.

FIG. 2A is a cross-sectional view showing a first glass substrate and a second glass substrate having a sealing material layer.

FIG. 2B is a cross-sectional view showing a first glass substrate and a second glass substrate to be laminated via a sealing material layer.

FIG. 2C is a cross-sectional view showing a sealing material layer to be irradiated with a laser beam through a second glass substrate.

FIG. 2D is a cross-sectional view showing a sealing layer sealing a space between a first glass substrate and a second glass substrate.

FIG. 3 is a plan view showing a first glass substrate to be employed in the process for producing an electronic device shown in FIGS. 2A-D.

FIG. 4 is a cross-sectional view along the A-A line in FIG. 3.

FIG. 5 is a plan view showing a second glass substrate to be employed in the process for producing an electronic device shown in FIGS. 2A-D.

FIG. 6 is a cross-sectional view along the A-A line in FIG. 5.

FIG. 7 is a reflected electron image (composition image) showing an observation result of a cross-section of a sealing layer of an electronic device of Example 1 by an analytical scanning electron microscope.

### DESCRIPTION OF EMBODIMENTS

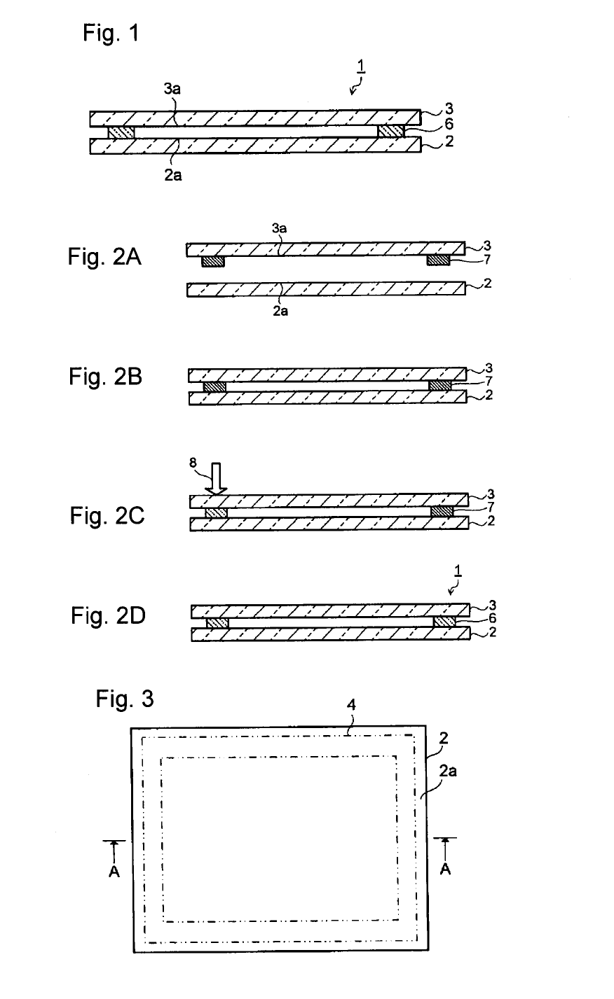

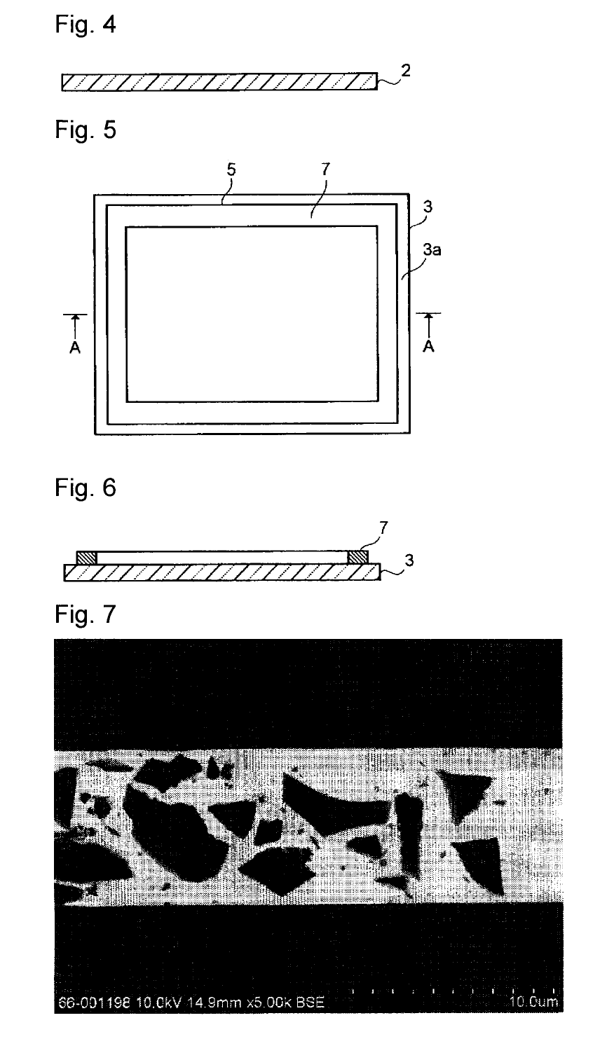

Now, embodiments for carrying out the present invention will be described with reference to Drawings. FIG. 1 is a view showing the construction of an electronic device according to an embodiment of the present invention. FIGS. 2A-D are views showing a process for producing an electronic device of the present invention. FIGS. 3 and 4 are views showing a construction of a first glass substrate to be employed for the process. FIGS. 5 and 6 are views showing the construction of a second glass substrate to be employed for the process.

An electronic device 1 shown in FIG. 1 constitutes e.g. a FPD such as OELD, FED, PDP or LCD, an illumination device (OEL etc.) employing a light-emitting element such as an OEL element, or a solar cell such as a dye-sensitized solar cell. The electronic device has a first glass substrate 2 and a second glass substrate 3. The first and second glass substrates 2 and 3 are each composed of e.g. soda lime glass having a known composition. The soda lime glass has a thermal expansion coefficient in the level of from 80 to 90×10⁻⁷/° C.

The materials of the glass substrates 2 and 3 are not limited to soda lime glass. This embodiment is suitable to an electronic device 1 employing glass substrates composed of a glass having a thermal expansion coefficient of at least 70×10⁻⁷/° C., more preferably glass substrates composed of a glass having a thermal expansion coefficient of at least 70×10⁻⁷/° C. and at most 100×10⁻⁷/° C. These glass substrates may be the same type of glass substrates having about the same thermal expansion coefficient, or they may be different types of glass substrates having different thermal expansion coefficients. Here, in a case of employing different types of glass substrates having different thermal expansion coefficients, the difference of the thermal expansion coefficient is preferably at most 60×10⁻⁷/° C., more preferably at most 30×10⁻⁷/° C. Such glasses may be silicate glass, borate glass, borosilicate glass, aluminosilicate glass, phosphate glass, fluorophosphate glass, etc. In this specification, the thermal expansion coefficients of the glass substrates 2 and 3 are each an average linear expansion coefficient in a temperature range of from 50 to 350° C.

An electronic element portion (not shown) corresponding to the electronic device 1 is provided between a surface 2a of the first glass substrate 2 and a surface 3a of the second glass substrate 3 facing to the surface 2a. When the electronic element portion is, for example, an OELD or an OEL illumination, the electronic element portion is provided with an OEL element; when the electronic element portion is a PDP, the electronic element portion is provided with a plasma light-emission element; when the electronic element portion is an LCD, the electronic element portion is provided with a liquid crystal display element; and when the electronic element portion is a solar cell, the electronic element portion is provided with e.g. a dye-sensitized solar cell element (dye-sensitized photoelectric conversion element). The electronic element portion provided with e.g. a display element, a light-emitting element or a dye-sensitized solar cell element has any one of various types of known structures. The structure of the electronic device 1 of this embodiment is not limited to the element structure of the electronic element portion. The electronic device 1 is suitable for a solar cell.

The electronic element portion in the electronic device 1 is constituted by e.g. an element film, an electrode film and a wiring film formed on at least one of the surfaces 2a and 3a of the first and second glass substrates 2 and 3. In e.g. an OELD, a FED or a PDP, an electronic element portion is constituted by an element structure formed on a surface 3a of one glass substrate 3. As an alternative, the electronic element portion may be constituted by an element structure formed on a surface 2a of the other glass substrate 2. In this case, the other glass substrate 2 (or the glass substrate 3) functions as a substrate for sealing, and an antireflective film or a color filter film, etc. may be formed on the substrate. Further, in e.g. a LCD or a dye-sensitized solar cell, an element film, an electrode film, a wiring film, etc. constituting an element structure are formed on each of the surfaces 2a and 3a of the glass substrates 2 and 3, and these films constitute an electronic element portion.

On the surface 2a of the first glass substrate 2 to be employed for producing the electronic device 1, a first sealing region 4 is provided as shown in FIG. 3. On the surface 3a of the second glass substrate 3, a second sealing region 5 corresponding to the first sealing region 4 is provided as shown in FIG. 5. The first and second sealing regions 4 and 5 form sealing layer-formed regions (for example, in a case of forming a sealing material layer in a second sealing region 6, the sealing material layer-formed region becomes a sealing region.). A portion encompassed by the first and second sealing regions 4 and 5 becomes an element region, and an electronic element portion is provided in the element region.

The first glass substrate 2 and the second glass substrate 3 are disposed with a predetermined gap so that the surface 2a having the first sealing region 4 faces to the surface 3a having the second sealing region 5. The gap between the first glass substrate 2 and the second glass substrate 3 is sealed by the sealing layer 6. The sealing layer 6 is formed between the sealing region 4 of the first glass substrate 2 and the sealing region 5 of the second glass substrate 3 so as to seal the electronic element portion. The electronic element portion provided between the first glass substrate 2 and the second glass substrate 3 is hermetically sealed by a glass panel constituted by the first glass substrate 2, the second glass substrate 3 and the sealing layer 6.

The sealing layer 6 is a melt-bonded layer bonded to the sealing region 4 of the first glass substrate 2 formed by melting and solidifying a sealing material layer 7 formed on the sealing region 5 of the second glass substrate 3. The sealing material layer 7 is melted by local heating using a laser beam 8. In the sealing region 5 of the second glass substrate 3 to be employed for producing the electronic device 1, a frame-shaped sealing material layer 7 is formed as shown in FIGS. 5 and 6. The sealing material layer 7 formed in the sealing region 5 of the second glass substrate 3 is rapidly heated by the laser beam 8 and rapidly cooled to melt-bond the layer to the sealing region 5 of the first glass substrate 2, thereby to form a sealing layer 6 hermetically sealing a space (element-disposition space) between the first glass substrate 2 and the second glass substrate 3.

Here, the sealing layer 6 may be a melt-bonded layer bonded to the sealing region 5 of the second glass substrate 3 produced by melting and solidifying a sealing material layer 7 formed on the sealing region 4 of the first glass substrate 2. As the case requires, respective sealing material layers may be formed on the sealing region 4 of the first glass substrate 2 and the sealing region 5 of the second glass substrate 3 and these sealing material layers may be melted and solidified together to form a sealing layer that is a melt-bonded layer between the sealing regions 4 and 5 of the first and second glass substrates 2 and 3. In these cases, formation of the sealing layer 6 is achieved in the same manner as the method described above.

The sealing material layer 7 is a fired layer of a sealing material (it is also referred to as glass material for sealing) containing a sealing glass composed of a low-melting glass (that is glass frit), a laser absorbent and a low expansion filler. The sealing material contains the low expansion filler in order to adjust the thermal expansion coefficient to the thermal expansion coefficient of the glass substrates 2 and 3. The sealing layer is one produced by blending the laser absorbent and the low expansion filler in a sealing glass being the main component. The sealing material may contain additives other than these components as the case requires.

The ratio of sealing glass (that is glass frit) contained in the above sealing material is preferably within a range of from 50 to 90% in terms of volume ratio. If the ratio of sealing glass is less than 50%, the strength of the sealing material layer becomes significantly low, and the bonding strength between the sealing material layer and the glass substrate also becomes significantly low. Accordingly, sealing with high reliability may not be achieved. If the ratio of the sealing glass is higher than 90%, the content ratio of the low expansion filler or the laser absorbent becomes low. If the content ratio of the low expansion filler is low, a stress produced at a time of laser sealing may not be sufficiently decreased and a crack may be formed. Further, if the content ratio of the laser absorbent is low, at a time of laser sealing, the sealing material layer may not sufficiently absorb the laser and the sealing material layer may not be melted.

As the sealing glass, for example, a low-melting point glass such as a bismuth glass, a tin-phosphate glass, a vanadium glass, a lead glass or a zinc borate alkali glass is employed. Among them, considering bonding property to glass substrates 2 and 3 and its reliability (for example, bonding reliability or sealing capability) or impact on environment or human body, etc., a sealing glass composed of a bismuth glass or a tin-phosphate glass is preferably employed. Particularly, at a time of forming a sealing layer 6 on glass substrates 2 and 3 composed of a glass having a thermal expansion coefficient of at least 70×10⁻⁷/° C., a bismuth glass is preferably employed.

The bismuth glass employed as the sealing glass (glass frit) preferably has a composition containing, as calculated as mass percentage of the following oxides, from 70 to 90% of Bi₂O₃, from 1 to 20% of ZnO and from 2 to 12% of B₂O₃. A glass basically composed of three components, i.e. Bi₂O₃, ZnO and B₂O₃, has such characteristics as transparency and low glass transition point, and accordingly, such a glass is suitable as a sealing material for laser heating. Bi₂O₃ is a component to form the network structure of glass. If the content of Bi₂O₃ is less than 70 mass %, the softening point of the low-melting point glass becomes high, and sealing at a low temperature becomes difficult. The content is preferably at least 75 mass %, more preferably at least 80 mass %. If the content of Bi₂O₃ exceeds 90 mass %, vitrification tends to be difficult and the thermal expansion coefficient tends to be too high. The content is preferably at most 87 mass %, more preferably at most 85 mass %.

ZnO is a component to lower thermal expansion coefficient or softening temperature, and the sealing glass preferably contains within a range of from 1 to 20 mass % of ZnO. If the content of ZnO is less than 1 mass %, vitrification becomes difficult. The content is preferably at least 5 mass %, more preferably at least 10 mass %. If the content of ZnO exceeds 20 mass %, stability at a time of forming a low-melting point glass becomes poor and devitrification tends to occur, whereby a glass may not be obtained. The content is preferably at most 17 mass %, more preferably at most 15 mass %. B₂O₃ is a component to expand a range wherein glass bone structure is formed and vitrification becomes possible, and the sealing glass preferably contains within a range of from 2 to 12 mass % of B₂O₃. If the content of B₂O₃ is less than 2 mass %, vitrification becomes difficult. The content is preferably at least 4 mass %. If the content of B₂O₃ exceeds 12 mass %, the softening point becomes high. The content is preferably at most 10 mass %, more preferably at most 7 mass %.

A bismuth glass basically composed of the above three components has a low glass transition point, and is suitable as the sealing material. The glass may contain an optional component such as Al₂O₃, CeO₂, SiO₂, Ag₂O, WO₃, MoO₃, Nb₂O₃, Ta₂O₅, Ga₂O₃, Sb₂O₃, Cs₂O, CaO, SrO, BaO, P₂O₅ or SnOₓ (x is 1 or 2). However, if the content of such an optional component is too large, the glass may become unstable to cause devitrification or the glass transition point or the softening point may become high. For this reason, the total content of the optional components is preferably at most 10 mass %. The lower limit of the total content of the optional components is not particularly limited. An effective amount of optional components may be blended in a bismuth glass (glass frit) according to the purpose of adding such components.

Among the above optional components, Al₂O₃, SiO₂, CaO, SrO, BaO etc. are components contributing to stabilization of glass, and their contents are each preferably within a range of from 0 to 5 mass %. Cs₂O provides an effect of lowering softening temperature, and CeO₂ provides an effect of stabilizing fluidity of glass. Ag₂O, WO₃, MoO₃, Nb₂O₃, Ta₂O₅, Ga₂O₃, Sb₂O₃, P₂O₅, SnOₓ, etc. may be contained as a component for adjusting the viscosity, the thermal expansion coefficient etc. of the glass. Contents of these components may be appropriately set within a range (including 0 mass %) wherein the total content of the optional components does not exceed 10 mass %. The glass composition in this case is adjusted so that the total amount of three basic components, i.e. Bi₂O₃, ZnO and B₂O₃, and optional components, basically becomes 100 mass %.

As the laser absorbent, at least one metal selected from the group consisting of Fe, Cr, Mn, Co, Ni and Cu or a compound such as an oxide containing the above metal, is employed. The laser absorbent may be a pigment other than these materials. The content of the laser absorbent is preferably within a range of from 0.1 to 5 volume % based on the sealing material. If the content of the laser absorbent is less than 0.1 volume %, the sealing material layer 7 may not be sufficiently melted at a time of irradiation of laser beam. If the content of the laser absorbent exceeds 5 volume %, local heating in the vicinity of an interface with the second glass substrate 3 occurs to cause breakage of the second glass substrate 3 or the fluidity of the sealing material at the time of melting may decrease to decrease the bonding property with the first glass substrate 2.

Further, the content of the laser absorbent is preferably within a range of at most 10 volume % based on the content of the low expansion filler. Namely, in volume percentage, an equation (content of laser absorbent)/(content of low expansion filler)<0.1 (that is, at most 10 volume %) is preferably satisfied. If the content of the laser absorbent exceeds 10 volume % based on the content of the low expansion filler, it becomes difficult to achieve both the lowering of the thermal expansion coefficient of the sealing material and improvement of the fluidity of the sealing material at a time of melting at the same time. The content of the laser absorbent is preferably at most 6 volume %, more preferably at most 4.3 volume % based on the content of the low expansion filler. Here, the lower limit of the content of the laser absorbent is preferably at least 1 volume % based on the content of the low expansion filler.

As the low expansion filler, at least one member selected from the group consisting of silica, alumina, zirconia, zirconium silicate, aluminum titanate, mullite, cordierite, eucryptite, spodumene, a zirconium phosphate compound, a tin oxide compound and a quartz solid solution, is preferably employed. As the zirconium phosphate compound, (ZrO)₂P₂O₇, NaZr₂(PO₄)₃, KZr₂(PO₄)₃, Ca_{0.5}Zr₂(PO₄)₃, Na_{0.5}Nb_{0.5}Zr_{1.5}(PO₄)₃, K_{0.5}Nb_{0.5}Zr_{1.5}(PO₄)₃, Ca_{0.25}Nb_{0.5}Zr_{1.5}(PO₄)₃, NbZr(PO₄)₃, Zr₂(WO₃)(PO₄)₂ or a complex compound of them, may be mentioned. Such a low expansion filler is one having a thermal expansion coefficient lower than that of the sealing glass being the main component of the sealing material.

The content of the low expansion filler is preferably within a range of from 10 to 50 volume % based on the sealing material (that is a sealing material containing the sealing glass, the laser absorbent and the low expansion filler). If the content of the low expansion filler is less than 10 volume %, it is not possible to sufficiently lower the thermal expansion coefficient of the sealing material. When the thermal expansion coefficient of the sealing material is large, as described above, a local rapid heating-rapid cooling process tends to cause formation of residual stress on the bonding interface between the glass substrates 2, 3 and the sealing layer 6 or its vicinity. The residual stress formed on the bonding interface or its vicinity causes to produce a crack or a breakage of the glass substrates 2, 3 or the sealing layer 6, or decreases the bonding strength or bonding reliability between the glass substrates 2, 3 and the sealing layer 6 or its vicinity. If the content of the low expansion filler exceeds 50 volume %, the fluidity of the sealing material in molten state decreases, which may cause a crack or a breakage of the glass substrate 2, 3 or the sealing layer 6, or lowers the bonding strength or the bonding reliability between the glass substrates and the sealing layer.

By the way, in a case of applying local heating by a laser beam 8 for heating the sealing material layer 7, as described above, a local rapid heating-rapid cooling process tends to cause formation of residual stress on the bonding interface between the glass substrates 2, 3 and the sealing layer 6 or its vicinity. The residual stress formed on the bonding interface or its vicinity causes a crack or a breakage in the glass substrates 2, 3 or the sealing layer 6, or causes to decrease the bonding strength or the bonding reliability between glass substrates 2, 3 and the sealing layer 6. Particularly, in a case of employing glass substrates 2,3 having a thermal expansion coefficient of at least 70×10⁻⁷/° C., when the glass substrates 2, 3 has a large thickness of at least 1.8 mm, a crack or a breakage of the glass substrates 2, 3 or the sealing layer 6 or lowering of the bonding strength or the bonding reliability tends to occur.

In the electronic device 1 of the present invention, when a cross-section of the sealing layer is observed, a value represented by the sum of perimeters of the low expansion filler and the laser absorbent present in a unit area of the cross-section of the sealing layer 6 (in this specification, the value is referred to as “fluidity inhibition value”) is from 0.7 to 1.3 μm⁻¹, and a value represented by the sum of a value that is the area ratio of the sealing glass in the unit area of the cross-section of the sealing layer multiplied by the thermal expansion coefficient of the sealing glass, and a value that is the area ratio of the low expansion filler and the laser absorbent in the unit area of the cross-section of the sealing layer multiplied by the thermal expansion coefficient of the low expansion filler (in this specification, the sum is referred to as “the thermal expansion value”) is from 50 to 90×10⁻⁷/° C. By employing such a sealing layer 6, it is possible to suppress generation of a crack or a breakage etc. in the glass substrates 2, 3 or the sealing layer 6, and to improve the bonding strength or the bonding reliability between the glass substrates 2, 3 and the sealing layer 6.

Here, the cross-section of the sealing layer 6 is observed by using an analytical scanning electron microscope. By subtracting an effect of concave-convex image from a reflected electron image captured by the analytical scanning electron microscope, a composition image (COMPO image) is obtained, whereby it is possible to distinguish the sealing glass from the inorganic filler containing the low expansion filler and the laser absorbent in the sealing layer 6. FIG. 7 shows the observation result of the cross-section of the sealing layer 6 of the electronic device 1 of Example 1 to be described later by an analytical scanning electron microscope, which is a composition image based on the reflected electron image. In FIG. 7, the central portion is a sealing layer, a bright portion in the sealing layer is the sealing glass, and dark portions correspond to an inorganic filler. By carrying out image analysis of such a composition image, it is possible to obtain the sum total (fluidity inhibition value) of the perimeters of the low expansion filler and the laser absorbent present in the unit area, the area ratio of the sealing glass and the sum total of the area ratios of the low expansion filler and the laser absorbent. The observation region of the sealing layer 6 by the analytical scanning electron microscope, may be any region in a cross-sectional portion of the sealing layer 6. The cross-section of the sealing layer 6 may be a cross-section of the sealed glass substrate in parallel with the scanning direction of the laser beam at the time of sealing, or it may be a cross-section perpendicular to the scanning direction of the laser beam. Further, in order to precisely obtain the fluidity inhibition value and the thermal expansion value, the cross-section of the sealing layer 6 is mirror-polished by using a polishing paper, an alumina particle dispersion liquid or a diamond particle dispersion liquid.

With respect to the thermal expansion value, a value that is the area ratio of the sealing glass obtained by image analysis of the composition image multiplied by the thermal expansion coefficient, and a value that is the sum total of area ratios of the low expansion filler and the laser absorbent obtained from image analysis of the composition image in the same manner, multiplied by the thermal expansion coefficient of the low expansion filler, are obtained and by summing up these values, the thermal expansion value is obtained. The thermal expansion coefficients of the sealing glass and the low expansion filler are each an average linear expansion coefficient in the temperature range of from 50 to 350° C. Further, since the laser absorbent is small in the content as compared with the low expansion filler and its contribution to thermal expansion value is small, the total thermal expansion value of these materials is approximated by a value that is the sum total of area ratios of the low expansion filler and the laser absorbent multiplied by the thermal expansion coefficient of the low expansion filler.

The perimeter of the low expansion filler and the laser absorbent is the sum total (μm) of a measured perimeter of the low expansion filler per a unit area (when a plurality of low expansion filler portions are present, the sum total of measured perimeters of the plurality of such portions) and a measured perimeter of the laser absorbent per a unit area (when a plurality of laser absorbent portions are present, the sum total of measured perimeters of such portions) when the image of the cross-section of the sealing layer is observed.

In a case of irradiating the sealing material layer 7 with a laser beam 8 to heat and melt the layer, the sealing material is melted and expanded by the laser irradiation, and on completion of the laser irradiation, the sealing material is rapidly cooled and shrunk. Since the heating by the laser beam 8 causes not only a high temperature-rising speed at a time of laser irradiation but also a high cooling speed after the laser irradiation, when the thermal expansion coefficient of the sealing material is large, the sealing material solidifies before it sufficiently shrinks. This causes to increase a residual stress formed on the bonding interface or its vicinity. Particularly, when the thermal expansion coefficients of the glass substrates 2 and 3 are large, in the same manner as the case of the sealing material, the heated portions of the glass substrates 2 and 3 solidify before they sufficiently shrink, and accordingly, a residual stress tends to be large. Further, when the thicknesses of the glass substrates 2 and 3 are large, temperature gradients in the glass substrates tend to be large. By these temperature gradients, expansion difference and shrink difference are formed in each of the glass substrates 2 and 3, whereby a residual stress tends to be large.

With respect to such a point, it is effective to use a sealing material having a small thermal expansion coefficient. Namely, by reducing the thermal expansion amount of the sealing material at a time of laser irradiation and thereby reducing shrinking amount, it is possible to suppress residual stress caused by the rapid heating-rapid cooling process. For this reason, the electronic device 1 of this embodiment is configured so that the thermal expansion value obtained by the cross-sectional observation of the sealing layer 6 becomes at most 90×10⁻⁷/° C. By making the thermal expansion value of the sealing layer 6 to be at most 90×10⁻⁷/° C., it becomes possible to reduce the residual stress due to defective shrinkage of the sealing material. The thermal expansion value of the sealing layer 6 is more preferably at most 88×10⁻⁷/° C., still more preferably at most 85×10⁻⁷/° C. Here, the lower limit of the thermal expansion value of the sealing layer is preferably at least 50×10⁻⁷1° C.

In order to make the thermal expansion value of the sealing layer 6 to be at most 90×10⁻⁷/° C., it is preferred to increase the content of the low expansion filler in the sealing material. Specifically, within a range of from 10 to 50 volume % of the low expansion filler is preferably contained in the sealing material. If the content of the low expansion filler in the sealing material is less than 10 volume %, it may not be possible to sufficiently lower the thermal expansion value of the sealing layer 6. In order to further lower the thermal expansion value of the sealing layer 6, the content of the low expansion filler is preferably at least 25 volume %.

Here, as the content of the low expansion filler increases, the thermal expansion value of the sealing layer 6 becomes low, but the increase of the content of the low expansion filler causes to decrease fluidity of the sealing material. In a case of using a sealing material containing a relatively large amount of low expansion filler, in order to achieve a sufficient fluidity of the sealing material at a time of heating and to obtain a sufficient bonding property of the sealing material to the glass substrates 2 and 3, it is necessary to raise the heating temperature of the sealing material layer 7 by the laser beam 8. When the heating temperature of the sealing material layer 7 becomes high, a temperature gradient formed in each of the glass substrates 2 and 3 at a time of rapid heating by the laser beam 8 becomes large, whereby a difference of expansion amounts is formed in each of the glass substrates 2 and 3. Namely, in the glass substrates 2 and 3, expansion amount only in the vicinity of the sealing layer 6 becomes large.

The difference of the thermal expansion value in each of the glass substrates 2 and 3 at the time of laser heating, becomes large as the thermal expansion coefficients of the glass substrates 2 and 3 are large and as the thicknesses of the substrates are large. Since this partial expansion cannot completely shrink at a time of rapid cooling, a tensile stress is formed in the vicinity of the sealing layer 6 in each of the glass substrates 2 and 3, which tends to cause a crack or a breakage in the glass substrates 2 and 3 and the sealing layer 6. By lowering the heating temperature in the sealing material layer 7 caused by the laser beam 8, it is possible to lower the tensile stress due to the temperature gradient in each of the glass substrates 2 and 3. However, when a sealing material containing a relatively large amount of low expansion filler is employed, even if the heating temperature of the sealing material is simply lowered, the fluidity decreases to decrease bonding property of the sealing material to the glass substrates 2 and 3.

To cope with this problem, in the electronic device 1 of this embodiment, the fluidity inhibition value obtained from cross-sectional observation of the sealing layer 6 is set to be at most 1.3 μm⁻¹. Namely, by reducing the sum total of the perimeters of the low expansion filler and the laser absorbent present in a unit area of the sealing layer 6, prevention of the fluidity of the sealing glass by the low expansion filler or the laser absorbent decreases. Namely, since the reduction of the fluidity of the sealing material decreases, it is possible to suppress rise of the heating temperature. Accordingly, the temperature gradient in each of the glass substrates 2 and 3 becomes small, whereby a resulting tensile stress can be reduced. The fluidity inhibition value of the sealing layer 6 is preferably at most 1.2 μm⁻¹, more preferably at most 1.1 μm⁻¹.

As the content of the low expansion filler in the sealing material increases, the thermal expansion value of the sealing layer 6 decreases, but the increase of the content of the low expansion filler causes to increase the fluidity inhibition value. For this reason, the thermal expansion value of the sealing layer is preferably set to be at least 50×10⁻⁷/° C. Further, the fluidity inhibition value is preferably set to be at least 0.7 μm⁻¹.

The heating temperature of the sealing material layer 7 is preferably set to be within a range of at least (T+100° C.) to at most (T+400° C.) based on the softening point temperature T (° C.) of the sealing glass. If the heating temperature of the sealing material layer 7 exceeds (T+400° C.), a temperature gradient formed in each of the glass substrates 2 and 3 becomes large, which causes to increase the tensile stress and a crack or a breakage, etc. tends to be formed in the glass substrates 2 and 3 or the sealing layer 6. If the heating temperature of the sealing material layer 7 is too low, its fluidity may become insufficient, and accordingly, the heating temperature of the sealing material layer 7 is preferably set to be at least (T+100° C.). In this specification, the softening point is defined as the fourth inflection point of differential thermal analysis (DTA).

In order to make the fluidity inhibition value of the sealing layer 6 to be at most 1.3 μm⁻¹, it is preferred to employ a low expansion filler having a small specific surface area. Specifically, the low expansion filler preferably has a specific surface area of at most 4.5 m²/g. If the specific surface area of the low expansion filler exceeds 4.5 m²/g, it is not possible to sufficiently lower the fluidity inhibition value of the sealing layer 6. In order to further reduce the fluidity inhibition value of the sealing layer 6, the specific surface area of the low expansion filler is more preferably set to be at most 3.5 m²/g. By removing particles of the low expansion filler having relatively small particle sizes, it is possible to reduce the specific surface area. Specifically, it is preferred to remove particles having particle sizes of at most 1 μm as much as possible. In order to further reduce the specific surface area of the low expansion filler, it is more preferred to remove particles having particle sizes of at most 2 μm as much as possible. In order to reduce particles having relatively small particle sizes, a known method employing e.g. a dry classifying machine or a wet classifying machine may be applied.

As described above, in the electronic device 1 of this embodiment, since the thermal expansion value obtained by cross-sectional observation of the sealing layer 6 is set to be from 50 to 90×10⁻⁷/° C. and the fluidity inhibition value is set to be from 0.7 to 1.3 μm⁻¹, it is possible to suppress generation of e.g. a crack or a breakage of the glass substrates 2 and 3 or the sealing layer 6, and to improve the bonding strength or the bonding reliability between the glass substrates 2, 3 and the sealing layer 6. However, if the thicknesses of the glass substrates 2 and 3 exceed 5 mm, the suppressing effect of e.g. the crack or the breakage decreases, and accordingly, the electronic device 1 of this embodiment is effective particularly in a case of employing glass substrates 2 and 3 having thicknesses of at most 5 mm.

Further, the crack or the breakage of the glass substrates 2 and 3 or the sealing layer 6 due to the residual stress tends to be formed when the thermal expansion coefficients of the glass substrates 2 and 3 are at least 70×10⁻⁷/° C. and further in a case where the thicknesses of the glass substrates 2 and 3 are at least 1.8 mm. Even in such cases, by making the thermal expansion value of the sealing layer 6 to be from 50 to 90×10⁻⁷/° C. and making the fluidity inhibition value to be from 0.7 to 1.3 μm⁻¹ thereby reducing the residual stress caused by defective shrinkage of the sealing material or the temperature gradient in the glass substrates 2 and 3, it is possible to suppress with good reproducibility generation of a crack or a breakage, etc in the glass substrates 2 and 3 or the sealing layer 6.

Here, even in a case of employing glass substrates 2 and 3 having thicknesses of less than 1.8 mm, not only it is possible to suppress generation of a crack or a breakage, etc. of the glass substrates 2 and 3 or the sealing layer 6, but also it is possible to improve bonding reliability between the glass substrates 2, 3 and the sealing layer 6. Accordingly, the electronic device 1 of this embodiment is effective not only in a case of employing glass substrates 2 and 3 having thicknesses of at least 1.8 mm but also in a case of employing glass substrates 2 and 3 having thicknesses of less than 1.8 mm. Further, the electronic device 1 of this embodiment is suitable for a solar cell.

A residual stress formed at a time of laser sealing not only causes a crack or a breakage, etc. of the glass substrates 2 and 3 or the sealing layer 6, but also causes to reduce the bonding strength or the bonding reliability. Particularly, to a solar cell disposed in outdoor places, a heat cycle produced by a temperature difference between day time and night time is repeatedly applied. Accordingly, when a residual stress is formed on a bonding interface, a crack or a breakage tends to be formed in the glass substrates 2 and 3 or the sealing layer 6. To cope with such a problem, by making the thermal expansion value of the sealing layer 6 to be from 50 to 90×10⁻⁷/° C. and making the fluidity inhibition value to be from 0.7 to 1.3 μm⁻¹, it is possible to improve bonding reliability at a time of using the electronic device 1 for e.g. a solar cell.

The electronic device 1 of this embodiment is, for example, produced in the following manner. First, as shown in FIG. 2A, a first glass substrate 2 and a second glass substrate 3 having a sealing material layer 7, are prepared. The sealing material layer 7 is formed by mixing a sealing material containing a sealing glass, a low expansion filler and a laser absorbent with a vehicle to prepare a sealing material paste, applying the sealing material paste on a sealing region 5 of the second glass substrate 3, and drying and firing the sealing material paste. The specific constructions of the sealing glass, the low expansion filler and the laser absorbent are as described above.

As the vehicle to be employed for preparing the sealing material paste, one prepared by dissolving a resin such as methylcellulose, ethylcellulose, carboxymethylcellulose, oxyethylcellulose, benzylcellulose, propylcellulose or nitrocellulose in a solvent such as terpineol, butyl carbitol acetate or ethyl carbitol acetate; or one prepared by dissolving an acrylic resin such as methyl(meth)acrylate, ethyl(meth)acrylate, butyl(meth)acrylate or 2-hydroxyethyl methacrylate in a solvent such as methylethyl ketone, terpineol, butyl carbitol acetate or ethyl carbitol acetate; may be mentioned.

The viscosity of the sealing material paste may be adjusted to a viscosity corresponding to an apparatus for coating the glass substrate 3, and it can be adjusted by changing the ratio between the resin (binder component) and the solvent or the ratio between the sealing material and the vehicle. To the sealing material paste, a known additive for glass paste, such as a solvent for dilution, a defoaming agent or a dispersing agent, may be added. For preparation of the sealing material paste, a known method employing e.g. a rotation type mixer provided with a stirring blade, a roll mill or a ball mill, may be applied.

The sealing material paste is applied on the sealing region 5 of the second glass substrate 3, and the sealing material paste is dried to form a coating layer of the sealing material paste. The sealing material paste is, for example, applied on the second sealing region 5 by using a printing method such as screen printing or gravure printing, or applied along the second sealing region 5 by using e.g. a dispenser. The coating layer of the sealing material paste is, for example, preferably dried at a temperature of at least 120° C. for at least 10 minutes. The drying step is carried out in order to remove a solvent in the coating layer. If a solvent remains in the coating layer, a binder component may not be sufficiently removed in the subsequent firing step.

The above coating layer of the sealing material paste is fired to form a sealing material layer 7. In the firing step, first, the coating layer is heated to a temperature of at most the glass transition point of the sealing glass (i.e. glass frit) being the main component of the sealing material, to remove a binder component in the coating layer, and thereafter, the coating layer is heated to a temperature of at least the softening point of the sealing glass (i.e. glass frit) to melt and fusion-bond the sealing material to the glass substrate 3. Thus, a sealing material layer 7 composed of a fired layer of the sealing material is formed.

Next, as shown in FIG. 2B, the first glass substrate 2 and the second glass substrate 3 are laminated so that their surfaces 2a and 3a face to each other via the sealing material layer 7. Next, as shown in FIG. 2C, the sealing material layer 7 is irradiated with a laser beam 8 through the second glass substrate 3 (or the first glass substrate 2). This laser beam 8 is radiated as it is scanned along the frame-shaped sealing material layer 7 formed in the peripheral portion of the glass substrate. The laser beam is not particularly limited, and a laser beam emitted from a semiconductor laser, a carbon dioxide laser, an excimer laser, a YAG laser, a HeNe laser, etc. is employed.

Each portion of the sealing material layer irradiated with the laser beam 8 scanned along the sealing layer 7 is melted, and on completion of the irradiation of the laser beam 8, the portion is rapidly solidified and melt-bonded to the first glass substrate 2. The heating temperature of the sealing material layer 7 by the laser beam 8 is, as described above, preferably within a range of at least (T+100° C.) and at most (T+400° C.) based on the softening point temperature T (° C.) of the sealing glass. Then, by irradiating the entire circumference of the sealing material layer 7 with the laser beam 8, as shown in FIG. 2D, a sealing layer 6 sealing a space between the first glass substrate 2 and the second glass substrate 3 is formed.

Thus, an electronic device 1 wherein an electronic element portion provided and hermetically sealed in a glass panel constituted by the first glass substrate 2, the second glass substrate 3 and the sealing layer 6, is produced. Since a residual stress formed on the bonding interface or its vicinity at the time of forming the sealing layer 6 by the laser beam 8 is reduced, it is possible to suppress generation of a crack or a breakage, etc. of the glass substrates 2 and 3 or the sealing layer 6. Further, since it is possible to increase the bonding strength and the bonding reliability between the glass substrates 2, 3 and the sealing layer 6, it becomes possible to supply an electronic device 1 excellent in reliability. Here, the glass panel inside of which is hermetically sealed can be applied not only to the electronic device 1 but also to a sealed electronic component or a glass member (for example, a building member) such as a multilayer glass.

Here, in this specification, for convenience, the glass substrate on which the above electronic element portion is formed is referred to as the first glass substrate, and this is a normal embodiment, but the namings of the first and the second glass substrates may be opposite.

### EXAMPLES

Next, specific examples of the present invention and their evaluation results will be described. Here, the following description does not limit the present invention, and the present invention can be modified in a form that meets the gist of the present invention.

### Example 1

A bismuth glass frit (softening point: 410° C., thermal expansion coefficient: 106×10⁻⁷/° C.) having a composition of, as calculated as the mass percentage of the following oxides, 83% of Bi₂O₃, 5% of B₂O₃, 11% of ZnO and 1% of Al₂O₃; a cordierite powder as a low expansion filler having an average particle size (D50) of 4.3 μm and a specific surface area of 1.6 m²/g; and a laser absorbent having an average particle size (D50) of 1.2 μm and a specific surface area of 6.1 m²/g, that is a compound containing Fe, Mn and Cu (specifically, the compound has a composition of, as calculated as mass percentage of the oxides, 16.0% of Fe₂O₃, 43.0% of MnO, 27.3% of CuO, 8.5% of Al₂O₃ and 5.2% of SiO₂); were prepared.

The particle size distribution of the cordierite powder was measured by employing a particle size analyzer (MICROTRAC HRA manufactured by Nikkiso Co., Ltd.). The measurement conditions were set as follows: measurement mode (HRA-FRA mode, particle transparency: yes, spherical particles: no, particle refractive index: 1.75, fluid refractive index: 1.33. A slurry prepared by dispersing the powder in water was further dispersed by ultrasonic waves before the measurement. The particle size distribution of the laser absorbent was measured by using a particle size analyzer (MICROTRAC HRA manufactured by Nikkiso Co., Ltd.). The measurement conditions were set as follows: measurement mode: HRA-FRA mode, particle transparency: yes, spherical particles: no, particle refractive index: 1.81, fluid refractive index: 1.33. A slurry prepared by dispersing the powder in water was further dispersed by ultrasonic waves before the measurement.

The specific surface areas of the cordierite powder and the laser absorbent were measured by employing a BET specific surface area measurement apparatus (Macsorb HM model-1201 manufactured by Montech Co., Ltd.). The measurement conditions were set to be as follows: adsorption material: nitrogen, carrier gas: helium, measurement method: fluid method (BET one point type), evacuation temperature: 200° C., evacuation time: 20 min, evacuation pressure: N₂ gas flow/atmospheric pressure, sample weight: 1 g. These conditions were applied also to other examples.

66.8 volume percent of the bismuth glass frit, 32.2 volume % of the cordierite powder and 1.0 vol % of the laser absorbent were mixed to prepare a sealing material (thermal expansion coefficient (50 to 350° C.): 66×10⁻⁷/° C.). 83 mass % of the sealing material was mixed with 17 mass % of a vehicle prepared by dissolving 5 mass % of ethylcellulose being a binder component in 95 mass % of 2,2,4-trimethyl-1,3 pentanediol monoisobutyrate, to prepare a sealing material paste.

Next, a second glass substrate composed of soda lime glass (AS (thermal expansion coefficient: 85×10⁻⁷/° C.) manufactured by Asahi Glass Company, Limited, size (high×long×thick): 50 mm×50 mm×2.8 mm) was prepared, and the sealing material paste was applied on a sealing region of the glass substrate by a screen printing method. In the screen printing, a screen stencil having a mesh size of 325 and an emulsion thickness of 20 μm was employed. The screen stencil had a frame-shaped pattern of 30 mm×30 mm having a line width of 0.75 mm, and the curvature radius of its corner portions was 2 mm. The coating layer of the sealing material paste was dried at 120° C. for 10 minutes, and thereafter, it was fired at 480° C. for 10 minutes to form a sealing material layer having a thickness of 15 μm and a line with of 0.75 mm.

Next, the second glass substrate having the sealing material layer was laminated with a first glass substrate (a substrate composed of soda lime glass, having the same composition and the same shape as those of the second glass substrate) having a solar cell region (a region on which a power generation region is formed). Subsequently, in a state that a pressure of 0.25 MPa was applied on the first glass substrate, the sealing material layer was irradiated with a laser beam (a semiconductor laser) having a wavelength of 808 nm, a spot diameter of 3.0 mm and a power of 70.0 W (power density: 990 W/cm²) through the first glass substrate with a scanning speed of 2 mm/sec, to melt and rapidly cool-solidify the sealing material layer to seal the first and the second glass substrates together. The intensity distribution of the laser beam was not shaped into a constant distribution, and a laser beam having a convex-shaped intensity distribution was employed.

The heating temperature of the sealing material layer at a time of laser beam irradiation was measured by a radiation temperature meter, and as a result, the temperature of the sealing material layer was 620° C. Since the softening point temperature T of the bismuth glass frit is 410° C., the heating temperature of the sealing material layer corresponds to (T+210° C.). After the laser sealing, the state of the glass substrates and the sealing layer were observed, and as a result, no formation of a crack or a breakage was observed, and it was confirmed that the first glass substrate and the second glass substrate were satisfactorily sealed together. Further, the air tightness of the glass panel that was formed by sealing the first glass substrate and the second glass substrate together, was evaluated by a helium-leakage test, it was confirmed that a good air tightness was obtained.

Next, the cross-section of the sealing layer was observed in the following manner. First, the laser-sealed glass substrates were cut by using a glass cutter and a glass pincers, and embedded in an epoxy resin. After curing of the embedding resin was confirmed, rough polishing with a polishing paper of silicon carbide was carried out, and subsequently, the cross-section of the sealing layer was mirror-polished by using an alumina particle dispersion liquid and a diamond particle dispersion liquid. On the cross-section of the sealing layer thus obtained, carbon was vapor-deposited to prepare an observation sample.

By using an analytical scanning electron microscope (SU6600 manufactured by Hitachi High-Technologies Corporation), reflected electron image observation of the cross-section of the sealing layer was carried out. The observation conditions were set to be as follows: acceleration voltage: 10 kV, electric current: small, image capturing size: 1,280×960 pixel, file format of image data: tagged image file format (tif). FIG. 7 shows an obtained reflected electron image of the cross-section of the sealing layer.

By using a two-dimensional image-analysis software (Win ROOF produced by Mitani Corporation), image analysis of the obtained reflected electron image of the cross-section of the sealing layer was carried out. The length per pixel was obtained by using a scale of an electron microscope photograph, and calibration was carried out. Subsequently, a portion of the cross-section of the sealing layer having no bubble, no flaw and no dirt was selected by “rectangular ROI”, and image processing was carried out by a 3×3 media filter to remove a noise. Subsequently, by using “digitization by two threshold values”, regions corresponding to the low expansion filler and the laser absorbent were distinguished from the region of the sealing glass.

An upper threshold value was set so that the regions corresponding to the low expansion filler and the laser absorbent were clearly distinguished from the regions corresponding to the sealing glass, and the area ratio of the low expansion filler and the laser absorbent was obtained. A lower threshold value at this time was set to be 0.000. Subsequently, by using a “perimeter length (a mode in which the length of a line connecting medium points between adjacent boundary pixels in the region is defined as the perimeter length)”, the perimeter lengths of the regions corresponding to the low expansion filler and the laser absorbent were obtained. Subsequently, the threshold values of the “digitization by two threshold values” were set to be from 0.000 to 255.000, and the total area of the regions selected by “rectangular ROI” was obtained.

By using the area ratio of the low expansion filler and the laser absorbent, the perimeter lengthes of the regions corresponding to the low expansion filler and the laser absorbent, and the total area of the selected region, that were obtained as described above, a thermal expansion value and a fluidity inhibition value were calculated. At this time, the thermal expansion coefficient of a bismuth glass was assumed to be 105×10⁻⁷/° C., the thermal expansion coefficient of the low expansion filler was assumed to be 15×10⁻⁷/° C. As a result, the fluidity inhibition value, that is the sum total of perimeter lengths of the low expansion filler and the laser absorbent present in a unit area, was 0.93 μm⁻¹. Further, the area ratio of the sealing glass was 66%, the sum total of the area ratios of the low expansion filler and the laser absorbent was 34%, and the thermal expansion value obtained from these values was 74×10″⁷/° C.

### Example 2

Formation of a sealing material layer and sealing of the first glass substrate and the second glass substrate together by a laser beam were carried out in the same manner as Example 1 except that a cordierite powder having an average particle size (D50) of 2.6 μm and a specific surface area of 4.5 m²/g was employed as a low expansion filler. The temperature of the sealing material layer at the time of irradiation of laser beam, was 620° C. in the same manner as in Example 1. The state of an electronic device having a glass panel thus produced, was observed, and as a result, no generation of a crack or a breakage was observed in the glass substrates or the sealing layer, and it was confirmed that these components were satisfactorily sealed together. Further, observation and image analysis of the cross-section of the sealing layer were carried out in the same manner as Example 1, and as a result, the fluidity inhibition value was 1.26 μm⁻¹ and the thermal expansion value was 74×10⁻⁷/° C.

### Example 3

Formation of the sealing material layer and the sealing of the first glass substrate and the second glass substrate together by a laser beam were carried out in the same manner as in Example 1 except that 74.5 volume % of the bismuth glass frit, 24.5 volume % of the cordierite powder and 1.0 volume % of the laser absorbent were mixed to produce a sealing material (thermal expansion coefficient (50 to 350° C.): 75×10⁻⁷/° C.). The temperature of the sealing material layer at the time of laser irradiation was 620° C. in the same manner as in Example 1. The state of an electronic device having a glass panel thus produced was observed, and as a result, no formation of a crack or a breakage was observed in the glass substrates or the sealing layer, and it was confirmed that these components were satisfactorily sealed together. Further, observation and image analysis of the cross-section of the sealing layer were carried out in the same manner as Example 1, and as a result, the fluidity inhibition value was 0.74 μm⁻¹ and the thermal expansion value was 88×10⁻⁷/° C.

### Example 4

Formation of the sealing material layer and the sealing of the first glass substrate and the second glass substrate together by a laser beam were carried out in the same manner as in Example 1 except that the sealing material paste was applied on a second glass substrate (manufactured by SCHOTT AG (thermal expansion coefficient: 72×10⁻⁷/° C.), size (high×long×thick): 50 mm×50 mm×1.1 mm) composed of borosilicate glass. Here, the first glass substrate was a substrate composed of borosilicate glass having the same composition and the same shape as those of the second glass substrate. The temperature of the sealing material layer at the time of laser beam irradiation was 620° C. in the same manner as Example. The state of an electronic device having a glass panel thus produced was observed, and as a result, no formation of a crack or a breakage was observed in the glass substrates or the sealing layer, and it was confirmed that these components were satisfactorily sealed together. Further, observation and image analysis of the cross-section of the sealing layer were carried out in the same manner as Example 1, and as a result, the fluidity inhibition value was 0.93 μm⁻¹ and the thermal expansion value was 74×10⁻⁷/° C.

### Example 5

72.6 volume % of a bismuth glass frit, 23.8 volume ° AD of a cordierite powder and 3.6 volume % of a laser absorbent were mixed to prepare a sealing material (thermal expansion coefficient (50 to 350° C.): 75×10⁻⁷/° C.). At this time, a cordierite powder having an average particle size (D50) of 2.6 μm and a specific surface area of 4.5 m²/g was employed as the low expansion filler. As the bismuth glass frit and the laser absorbent, ones the same as Example 1 were employed.

83 mass % of the sealing material was mixed with 17 mass % of a vehicle prepared by dissolving 5 mass % of ethylcellulose being a binder component in 95 mass % of 2,2,4-trimethyl-1,3 pentadiol monoisobutyrate, to prepare a sealing material paste.

Next, a second glass substrate composed of soda lime glass (AS (thermal expansion coefficient: 85×10⁻⁷/° C.) manufactured by Asahi Glass Company, Limited, size (high×long×thick): 50 mm×50 mm×2.8 mm) was prepared, and the sealing material paste was applied on a sealing region of the glass substrate by a screen printing method. For the screen printing, a screen stencil having a mesh size of 325 and an emulsion thickness of 5 μm was employed. The screen stencil has a frame-shaped pattern of 30 mm×30 mm having a line width of 0.5 mm, and the curvature radius R of its corner portions was 2 mm. The coating layer of the sealing material paste was dried under a condition of 120° C. for 10 minutes, and it was fired under a condition of 480° C. for 10 minutes, to form a sealing material layer having a thickness of 7 μm and a line width of 0.5 mm.

Next, the second glass substrate having the sealing material layer was laminated with a first glass substrate (a substrate made of soda lime glass having the same composition and the same shape as those of the second glass substrate) having a solar cell region (region on which a power generation layer was formed). Subsequently, in a state that a pressure of 0.25 MPa was applied on the first glass substrate, the sealing material layer was irradiated with a laser beam (semiconductor laser) having a wavelength of 808 nm, a spot diameter of 1.5 mm and a power of 17.0 W (power density: 960 W/cm²) through the first glass substrate with a scanning speed of 10 mm/sec, to melt and rapidly solidify the sealing material layer to seal the first glass substrate and the second glass substrate together. The intensity distribution of the laser beam was not shaped into a constant distribution, and a laser beam having a convex intensity distribution was employed.

The temperature of the sealing material layer at the time of laser beam irradiation was 620° C. in the same manner as Example 1. The state of an electronic device having a glass panel thus produced was observed, and as a result, no formation of a crack or a breakage was observed in the glass substrates or the sealing layer, and it was confirmed that these components were satisfactorily sealed together. Further, observation and image analysis of the cross-section of the sealing layer were carried out in the same manner as Example 1, and as a result, the fluidity inhibition value was 1.0 μm⁻¹ and the thermal expansion value was 88×10⁻⁷/° C.

### Comparative Example 1

The formation step of the sealing material layer and the sealing step of the first glass substrate and the second glass substrate together by a laser beam were carried out in the same manner as Example 1 except that a cordierite powder having an average particle size (D50) of 1.7 μm and a specific surface area of 5.3 m²/g was employed as the low expansion filler. As a result, breakage was formed in the glass substrate at the time of laser sealing, and it was not possible to seal the glass substrate together. Further, observation and image analysis of the cross-section of the sealing layer after laser irradiation were carried out in the same manner as Example 1, and as a result, the fluidity inhibition value was 1.39 μm⁻¹ and the thermal expansion value was 74×10⁻⁷/° C.

### Comparative Example 2

The formation step of the sealing material layer and the sealing step of the first glass substrate and the second glass substrate together by a laser beam were carried out in the same manner as Example 1 except that 79.0 volume % of a bismuth glass frit, 20.0 volume % of the cordierite powder and 1.0 volume % of the laser absorbent were mixed to prepare a sealing material (thermal expansion coefficient (50 to 350° C.): 80×10⁻⁷/° C.). As a result, breakage was formed in the glass substrate at the time of laser sealing, and it was not possible to seal the glass substrates together. Further, observation and image analysis of the cross-section of the sealing layer after the laser irradiation were carried out in the same manner as Example 1, and as a result, the fluidity inhibition value was 0.70 μm⁻¹ and the thermal expansion value was 96×10⁻⁷/° C.

Table 1 shows the preparation conditions, the fluidity inhibition values and thermal expansion values obtained from cross-sectional observation of the sealing layers, and the states after laser sealing of the electronic devices in the above Examples 1 to 5 and Comparative Examples 1 and 2. As evident from Table 1, in each of Examples 1 to 5 wherein sealing layer had a fluidity inhibition value of from 0.7 to 1.3 μm⁻¹ and the thermal expansion value of from 50 to 90×10⁻⁷/° C., good sealing state was obtained, and the residual stress at the time of laser sealing was reduced.

A laser beam was used as a heating source in each of the above Examples, but it is also possible to use electromagnetic waves such as infrared rays besides such a laser beam.

TABLE 1

| | | | | | | | | | Comp. | Comp. |
|---|---|---|---|---|---|---|---|---|---|---|
| | | | | Ex. 1 | Ex. 2 | Ex. 3 | Ex. 4 | Ex. 5 | Ex. 1 | Ex. 2 |
| Sealing | Glass frit | Material | | Bismuth glass | | | | | | |
| material | | Content (vol %) | | 66.8 | 66.8 | 74.5 | 66.8 | 72.6 | 66.8 | 79.0 |
| | Low | Material | | Cordierite | | | | | | |
| | expansion | Particle | Average particle | 4.3 | 2.6 | 4.3 | 4.3 | 2.6 | 1.7 | 4.3 |
| | filler | shape | size (μm) | | | | | | | |
| | | | Specific surface | 1.6 | 4.5 | 1.6 | 1.6 | 4.5 | 5.3 | 1.6 |
| | | | area (m²/g) | | | | | | | |
| | | Content (vol %) | | 32.2 | 32.2 | 24.5 | 32.2 | 23.8 | 32.2 | 20.0 |
| | Laser | Material | | Fe—Cr—Mn—Co—O | | | | | | |
| | absorbent | Particle | Average particle | 1.2 | 1.2 | 1.2 | 1.2 | 1.2 | 1.2 | 1.2 |
| | | shape | size (μm) | | | | | | | |
| | | | Specific surface | 6.1 | 6.1 | 6.1 | 6.1 | 6.1 | 6.1 | 6.1 |
| | | | area (m²/g) | | | | | | | |

| | | | | | | | |
|---|---|---|---|---|---|---|---|
| Content (vol %) | 1.0 | 1.0 | 1.0 | 1.0 | 3.6 | 1.0 | 1.0 |

| | | | | | | | |
|---|---|---|---|---|---|---|---|
| Thermal expansion coefficient | 66 | 66 | 75 | 66 | 75 | 66 | 80 |
| (×10⁻⁷/° C.) | | | | | | | |

| Glass substrate | Material | Soda lime glass | | | Borosilicate | Soda lime glass | | |
|---|---|---|---|---|---|---|---|---|
| | | | | | glass | | | |
| | Thermal expansion | 85 | | | 72 | 85 | | |
| | coefficient (×10⁻⁷/° C.) | | | | | | | |
| | Thickness (mm) | 2.8 | | | 1.1 | 2.8 | | |
| Sealing layer | Fluidity inhibition value | 0.93 | 1.26 | 0.74 | 0.93 | 1.0 | 1.39 | 0.70 |
| | (μm⁻¹) | | | | | | | |
| | Thermal expansion value | 74 | 74 | 88 | 74 | 88 | 74 | 96 |
| | (×10⁻⁷/° C.) | | | | | | | |

| | | | | | | | |
|---|---|---|---|---|---|---|---|
| Sealing state | Good | Good | Good | Good | Good | Breakage | Breakage |

### INDUSTRIAL APPLICABILITY

With the electronic device of the present invention, it is possible to suppress e.g. a crack or a breakage of substrates or a sealing material layer at a time of laser-sealing two glass substrates together, and to provide with good reproducibility an electronic device wherein the sealing property between the glass substrates and its reliability are improved.

This application is a continuation of PCT Application No. PCT/JP2011/063717, filed on Jun. 15, 2011, which is based upon and claims the benefit of priority from Japanese Patent Application No. 2010-137641 filed on Jun. 16, 2010. The contents of those applications are incorporated herein by reference in its entirety.

### REFERENCE SYMBOLS

1 . . . Electronic device, 2 . . . first glass substrate, 3 . . . second glass substrate, 4 . . . first sealing region, 5 . . . second sealing region, 6 . . . sealing layer, 7 . . . sealing material layer, 8 . . . laser beam

What is claimed is:

1. An electronic device which comprises:
a first glass substrate having a first surface having a first sealing region;
a second glass substrate having a second surface having a second sealing region corresponding to the first sealing region and disposed so that the second surface faces the first surface of the first glass substrate with a predetermined gap;
an electronic element portion provided between the first glass substrate and the second glass substrate; and
a sealing layer formed between the first sealing region of the first glass substrate and the second sealing region of the second glass substrate so as to seal the electronic element portion, the sealing layer comprising a melt-bonded layer of a sealing material containing a sealing glass, a low expansion filler and a laser absorbent;
wherein the sealing layer has a fluidity inhibition value of from 0.7 to 1.3 μm⁻¹, the fluidity inhibition value being represented by the sum of perimeters of the low expansion filler and the laser absorbent present in a unit area of a cross-section of the sealing layer; and the sealing layer has a thermal expansion value of from 50 to 90×10⁻⁷/° C., the thermal expansion value being represented by the sum of a value that is the area ratio of the sealing glass in the unit area of the cross-section of the sealing layer multiplied by the thermal expansion coefficient of the sealing glass, and a value that is the area ratio of the low expansion filler and the laser absorbent in the unit area of the cross-section of the sealing layer multiplied by the thermal expansion coefficient of the low expansion filler.

2. The electronic device according to claim 1, wherein the first and second glass substrates each has a thickness of at most 5 mm and comprises a glass having a thermal expansion coefficient of at least 70×10⁻⁷/° C.

3. The electronic device according to claim 1, wherein the sealing glass comprises a bismuth glass containing, as represented as mass percentage of the following oxides, from 70 to 90% of Bi₂O₃, from 1 to 20% of ZnO and from 2 to 12% of B₂O₃.

4. The electronic device according to claim 1, wherein the low expansion filler comprises at least one member selected from the group consisting of silica, alumina, zirconia, zirconium silicate, aluminum titanate, mullite, cordierite, eucryptite, spodumene, a zirconium phosphate compound, a tin oxide compound and a quartz solid solution, and the sealing material contains the low expansion filler in an amount within a range of from 10 to 50% in terms of volume ratio.

5. The electronic device according to claim 1, wherein the laser absorbent comprises at least one metal selected from the group consisting of Fe, Cr, Mn, Co, Ni and Cu or a compound containing the metal, and the sealing material contains the laser absorbent in an amount within a range of from 0.1 to 5% in terms of volume ratio.

6. The electronic device according to claim 1, wherein the sealing material contains the laser absorbent in an amount within a range of at most 10% in terms of volume ratio based on the low expansion filler.

7. The electronic device according to claim 1, wherein the sealing glass contains in an amount within a range of from 50 to 90% in terms of volume ratio based on the sealing material.

8. The electronic device according to claim 1, wherein the sealing layer is a layer formed by irradiating a sealing material layer containing the sealing glass, the low expansion filler and the laser absorbent, with a laser beam to heat the layer, and melt-bonding the sealing material layer.
